(19) United States
(12) Patent Application Publication
(10) Pub. No.: US 2025/0033446 A1
(43) Pub. Date: Jan. 30, 2025

(54) WINDSHIELD AND ROOF ASSEMBLY FOR AN OFF-ROAD VEHICLE

(71) Applicant: BOMBARDIER RECREATIONAL PRODUCTS INC., Valcourt (CA)

(72) Inventors: Dany PICHETTE, Sherbrooke (CA); Cecile EECKHOUDT, Magog (CA)

(21) Appl. No.: 18/763,269

(22) Filed: Jul. 3, 2024

Related U.S. Application Data
(60) Provisional application No. 63/515,974, filed on Jul. 27, 2023.

(51) Int. Cl. B60J 7/14; B60J 1/04

(52) U.S. Cl. CPC B60J 7/14; B60J 1/04

(57) ABSTRACT

A windshield and roof assembly for a vehicle and an off-road vehicle. The vehicle includes a frame including a rollover protection structure and a windshield and roof assembly. The assembly includes a windshield including a top edge, and a lower edge opposite the top edge; a roof including a front edge, and a rear edge opposite the front edge; and at least one hinge assembly including a vehicle portion connected to the rollover protection structure, a windshield portion rotationally connected to the vehicle portion, the windshield being connected to the windshield portion near the top edge of the windshield, and a roof portion rotationally connected to the vehicle portion, the roof being connected to the roof portion near the front edge of the roof.

### CROSS-REFERENCE

The present application claims priority from U.S. Provisional Patent Application No. 63/515,974, entitled “WINDSHIELD AND ROOF ASSEMBLY FOR AN OFF-ROAD VEHICLE” filed Jul. 27, 2023, the entirety of which is incorporated by reference herein.

### FIELD OF TECHNOLOGY

The present technology relates to windshield and roof assemblies for off-road vehicles.

### BACKGROUND

There exist various types of vehicles used mainly in off-road conditions. One such type is the side-by-side off-road vehicle (SSV). The name “side-by-side” refers to the seating arrangement of the vehicle in which the driver and a passenger are seated side-by-side. Some side-by-side off-road vehicles also have a second row of seats to accommodate one or more additional passengers. These vehicles typically have an open cockpit, a roll cage, and a steering wheel.

Since SSVs operate in off-road conditions, the environment in which they operate tends to be dustier, to have more debris, and to be wetter than the environment in which on-road vehicles typically operate. It is therefore sometimes desirable to provide a windshield and/or roof to aid in protecting or providing comfort to users of such a vehicle.

However, the protection from the environment provided by the windshield and/or roof can also negatively affect the flow of air through the generally open cockpit vehicle. It may be desirable to at least partially open the windshield and/or the roof to improve airflow, for instance in hot weather.

Thus there is a desire for optionally increasing air flow and/or access to the cockpit of an off-road vehicle that is suitable for the operating conditions thereof.

### SUMMARY

It is an object of the present technology to ameliorate at least some of the inconveniences present in the prior art.

According to one aspect of the present technology, there is provided a windshield and roof assembly for an off-road vehicle, the assembly including a windshield including a top edge, and a lower edge opposite the top edge; a roof including a front edge, and a rear edge opposite the front edge; and at least one hinge assembly including a vehicle portion configured for connecting to a frame member of the vehicle, a windshield portion pivotally connected to the vehicle portion, the windshield being connected to the windshield portion near the top edge of the windshield, and a roof portion pivotally connected to the vehicle portion, the roof being connected to the roof portion near the front edge of the roof.

According to some embodiments of the present technology, the at least one hinge assembly is configured such that, when the windshield and roof assembly is installed on the off-road vehicle: the vehicle portion is connected to the frame member of the vehicle; the windshield is pivotable between at least a lowered position and a raised position, the lower edge of the windshield being vertically higher in the raised position than in the lowered position; and the roof is pivotable between at least a closed position and a lifted position, the rear edge of the roof being vertically higher in the lifted position than in the closed position.

According to some embodiments of the present technology, the windshield portion pivots about a first axis relative to the vehicle portion; the roof portion pivots about a second axis relative to the vehicle portion, the second axis being parallel to the first axis.

According to some embodiments of the present technology, the windshield portion is fastened to the windshield; and the roof portion is fastened to the roof.

According to some embodiments of the present technology, the windshield portion and the roof portion pivot about a same pivot axis relative to the vehicle portion.

According to some embodiments of the present technology, the roof portion is disposed between the vehicle portion and the windshield portion circumferentially about the pivot axis.

According to some embodiments of the present technology, the windshield further includes at least one latch for selectively maintaining the windshield in the lowered position, the at least one latch being connected near the lower edge of the windshield.

According to some embodiments of the present technology, the at least one hinge assembly includes: a left hinge assembly connected to a left side portion of the windshield and a left side of the roof; and a right hinge assembly connected to a right side portion of the windshield and a right side of the roof.

According to some embodiments of the present technology, the at least one hinge assembly is a plurality of hinge assemblies connected to the windshield and the roof.

According to some embodiments of the present technology, the vehicle portion includes a vehicle portion body configured to be fastened to the vehicle, and a vehicle portion knuckle; the windshield portion includes a windshield portion body fastened to the windshield, and a windshield portion knuckle; the roof portion includes a roof portion body fastened to the roof, and a roof portion knuckle; and a pin extending through the vehicle portion knuckle, the windshield portion knuckle, and the roof portion knuckle.

According to another aspect of the present technology, there is provided an off-road vehicle including a frame including a rollover protection structure; two front wheels operatively connected to the frame; two rear wheels operatively connected to the frame; at least one seat supported by the frame; a motor supported by the frame and being operatively connected to at least one of: the two rear wheels; and the two front wheels; and a windshield and roof assembly including a windshield including a top edge, and a lower edge opposite the top edge; a roof including a front edge, and a rear edge opposite the front edge; and at least one hinge assembly including a vehicle portion connected to the rollover protection structure, a windshield portion rotationally connected to the vehicle portion, the windshield being connected to the windshield portion near the top edge of the windshield, and a roof portion rotationally connected to the vehicle portion, the roof being connected to the roof portion near the front edge of the roof.

According to some embodiments of the present technology, the windshield is pivotable between at least a lowered position and a raised position, the lower edge of the windshield being vertically higher in the raised position than in the lowered position; and the roof is pivotable between at least a closed position and a lifted position, the rear edge of the roof being vertically higher in the lifted position than in the closed position.

According to some embodiments of the present technology, in the lifted position of the roof, the rear edge of the roof is vertically higher than the front edge of the roof.

According to some embodiments of the present technology, a passenger cabin of the vehicle is at least partially defined by the rollover protection structure; the roof selectively closes an upper portion of the passenger cabin; in the closed position of the roof, the roof impedes access to the upper portion of the passenger cabin; and in the lifted position of the roof, the upper portion of the passenger cabin is accessible and fluidly connected to ambient air surrounding the vehicle.

According to some embodiments of the present technology, the windshield selectively closes a forward portion of the passenger cabin; in the lowered position of the windshield, the windshield impedes access to the forward portion of the passenger cabin; and in the raised position of the windshield, the forward portion of the passenger cabin is accessible and fluidly connected to ambient air surrounding the vehicle through a forward portion of the vehicle.

According to some embodiments of the present technology, the windshield portion pivots about a first axis relative to the vehicle portion and the roof portion pivots about a second axis relative to the vehicle portion, the second axis being parallel to the first axis.

According to some embodiments of the present technology, the windshield portion and the roof portion pivot about a same pivot axis relative to the vehicle portion.

According to some embodiments of the present technology, the roof portion is disposed between the vehicle portion and the windshield portion circumferentially about the pivot axis.

According to some embodiments of the present technology, the windshield further includes at least one latch for selectively maintaining the windshield in the lowered position, the at least one latch being connected near the lower edge of the windshield.

According to some embodiments of the present technology, the at least one hinge assembly includes a left hinge assembly connected to the windshield, the roof, and the frame left of a longitudinal centerline of the windshield and a right hinge assembly connected to the windshield, the roof, and the frame right of the longitudinal centerline of the windshield.

For purposes of this application, terms related to spatial orientation such as forwardly, rearward, upwardly, downwardly, left, and right, are as they would normally be understood by a driver of the vehicle sitting thereon in a normal riding position. Terms related to spatial orientation when describing or referring to components or sub-assemblies of the vehicle, separately from the vehicle should be understood as they would be understood when these components or sub-assemblies are mounted to the vehicle, unless specified otherwise in this application. In the event of a discrepancy between an explanation in the present application and an explanation in a document incorporated herein by reference, the explanation in the present application takes precedence.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, front, left side perspective view of a side-by-side off-road vehicle according to a non-limiting embodiment of the present technology;

FIG. 2 is a top, front, left side perspective view of a rollover protection system (ROPS) and a windshield and roof assembly of the vehicle of FIG. 1;

FIG. 3 is the top, front, left side perspective view of the ROPS and the windshield and roof assembly of FIG. 2, with a windshield being in a raised position;

FIG. 4 is the top, front, left side perspective view of the ROPS and the windshield and roof assembly of FIG. 2, with a roof being in a lifted position;

FIG. 5 is the top, front, left side perspective view of the ROPS and the windshield and roof assembly of FIG. 2, with the windshield being in the raised position and the roof being in the lifted position;

FIG. 6 is a top, front, left side perspective view of a hinge assembly of the windshield and roof assembly of FIG. 2, with the hinge assembly being arranged to position the windshield in a lowered position and the roof in a closed position;

FIG. 7 is the top, front, left side perspective view of the hinge assembly of FIG. 6, with the hinge assembly being arranged to position the windshield in the raised position and the roof in the closed position;

FIG. 8 is the top, front, left side perspective view of the hinge assembly of FIG. 6, with the hinge assembly being arranged to position the windshield in the lowered position and the roof in the lifted position; and

FIG. 9 is the top, front, left side perspective view of the hinge assembly of FIG. 6, with the hinge assembly being arranged to position the windshield in the raised position and the roof in the lifted position.

It should be noted that the Figures may not be drawn to scale.

### DETAILED DESCRIPTION

The present technology will be described with respect to a four-wheel off-road vehicle 10 having two side-by-side seats and a steering wheel. However, it is contemplated that some aspects of the present technology may apply to other types of vehicles such as, but not limited to, off-road vehicles having more or less than four wheels.

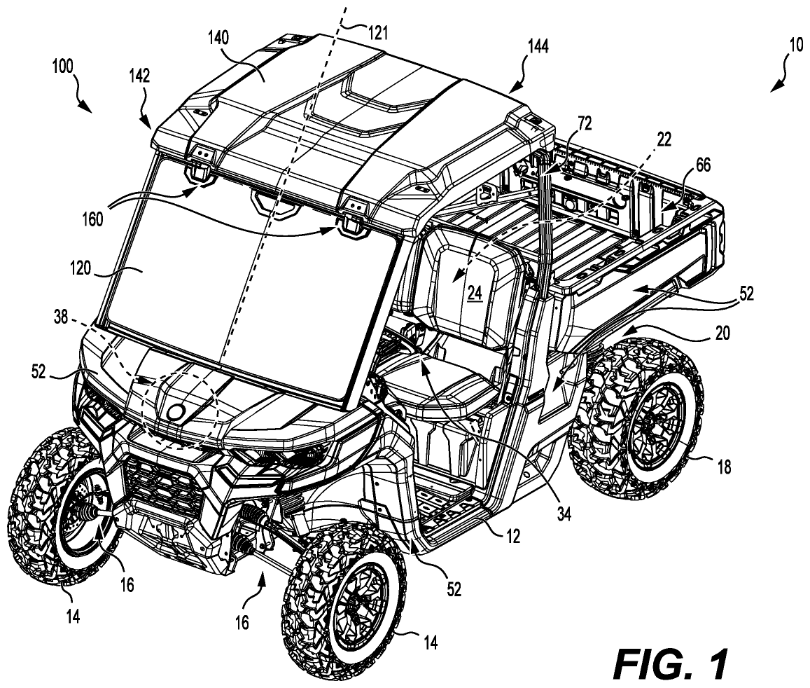

The general features of the off-road vehicle 10 will be described with respect to FIG. 1. The vehicle 10 has a frame 12, two front wheels 14 connected to a front of the frame 12 by front suspension assemblies 16 and two rear wheels 18 (only one being shown) connected to the frame 12 by rear suspension assemblies 20.

The frame 12 includes a rollover protection structure (ROPS) 72 defining a central cockpit area 22. Inside the central cockpit area 22, also referred to as a passenger cabin 22, are disposed a driver seat 24 and a passenger seat (not shown). The seats 24 are disposed side-by-side. In the present embodiment, the driver seat 24 is disposed on the left side of the vehicle 10 and the passenger seat is disposed on the right side of the vehicle 10. However, it is contemplated that the driver seat 24 could be disposed on the right side of the vehicle 10 and that the passenger seat could be disposed on the left side of the vehicle 10. It is contemplated that in some embodiments, the seats 24 could be replaced by a bench seat with two or more seating positions or by other types of seats.

A steering wheel 34 is disposed in front of the driver seat 24. The steering wheel 34 is used to turn the front wheels 14 to steer the vehicle 10. Various displays and gauges (not shown) are provided in the cockpit area 22 to provide information to the driver regarding the operating conditions of the vehicle 10. Examples of displays and gauges include, but are not limited to, a speedometer, a tachometer, a fuel gauge, a transmission position display, and an oil temperature gauge.

The vehicle 10 includes a motor 38 (shown schematically) connected to and supported by the frame 12. In the present embodiment, the motor 38 is an internal combustion engine, but it is contemplated that various types of motors could be used such as, but not limited to, in-line engines, V-type engines, two-stroke or four-stroke engines, electric motors, hybrid motors, and diesel engines. The motor 38 is operatively connected via a transmission (not shown) to one or both of the two rear wheels 18 and the two front wheels 14 for driving the vehicle 10.

The vehicle 10 further includes body panels 52 are connected to the frame 12. The panels help protect the internal components of the vehicle 10 and provide some of the aesthetic features of the vehicle 10. On each side of the vehicle 10, the side panels 52 define a passage through which a driver or passenger (depending on the side of the vehicle 10) can enter or exit the passenger cabin 22 of the vehicle 10. In some embodiments, the vehicle 10 could be provided with doors to selectively close the passages. At the rear of the vehicle 10, the side panels 52 define a cargo space 66 therebetween, rearward of the seats 24.

As is mentioned briefly above, the frame 12 includes the rollover protection structure (ROPS) 72, also known as a roll cage 72. The ROPS 72 is disposed over and partially defines the passenger cabin 22. The ROPS 72 is made of a plurality of hollow steel tubes, but other materials are contemplated.

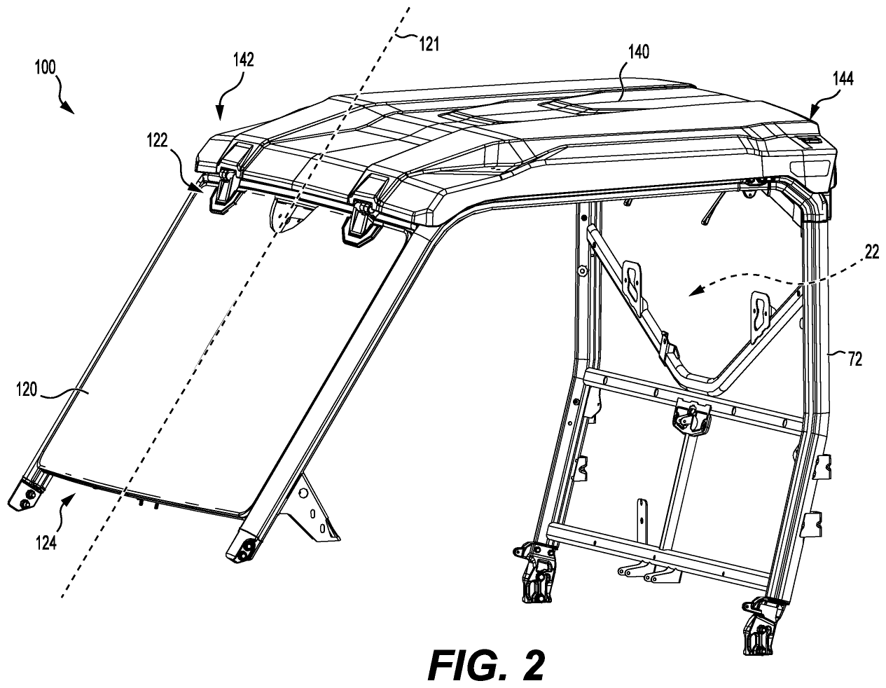

According to the present technology and with additional reference to FIGS. 2 to 5, the vehicle 10 is provided with a windshield and roof assembly 100, also referred to herein as the assembly 100. In at least some embodiments, the vehicle 10 could be assembled with the assembly 100 as first constructed. In other embodiments, the assembly 100 could be provided separately and selectively connected to the ROPS 72 by an owner or user of the vehicle 10. While the assembly 100 can be provided as a kit for installation on the vehicle 10, the assembly 100 will be described herein as connected to the vehicle 10.

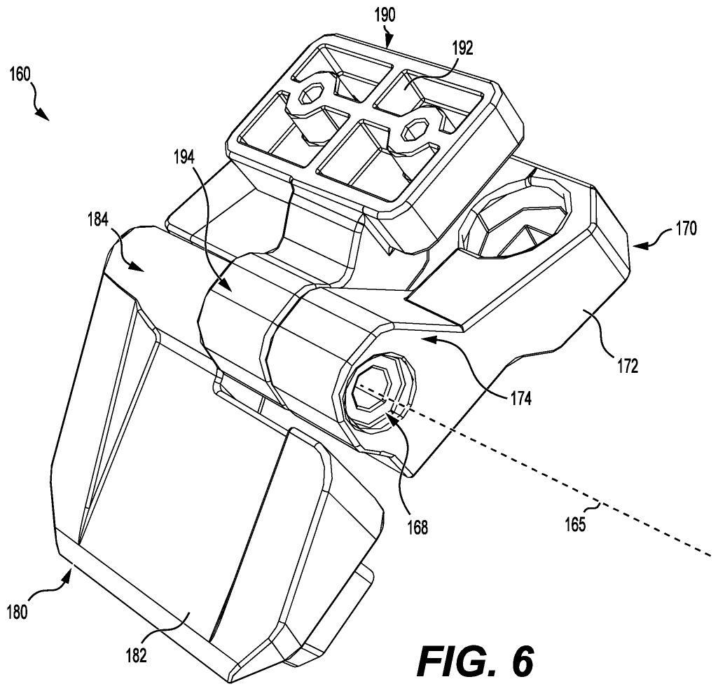

The windshield and roof assembly 100 includes a windshield 120, a roof 140, and two hinge assemblies 160, also referred to herein as the hinges 160. One of the hinges 160 is shown in isolation in FIGS. 6 to 9 and will be described in more detail below. Broadly, the hinges 160 provide a pivoting connection between the windshield 120, the roof 140, and the ROPS 72. The hinges 160 are connected to an upper, forward portion of the ROPS 72. Each of the windshield 120 and the roof 140 is connected to the hinges 160, with the hinges 160 providing selectively pivoting movement of the windshield 120 and the roof 140 relative to the ROPS 72.

In the illustrated embodiment, the assembly 100 includes two hinges, a left hinge 160 disposed to the left of a longitudinal centerline 121 of the windshield 120 and a right hinge 160 disposed to the right of the centerline 121.

The windshield 120 is disposed on the vehicle 10 forward of the seats 24. The windshield 120 is connected to the frame 12, specifically to the ROPS 72 via the hinges 160, at a top portion of the windshield 120. The windshield 120 is made from a transparent material such as glass or polycarbonate, although the specific material could vary. The windshield 120 is planar, but it is contemplated that it could be curved in different embodiments.

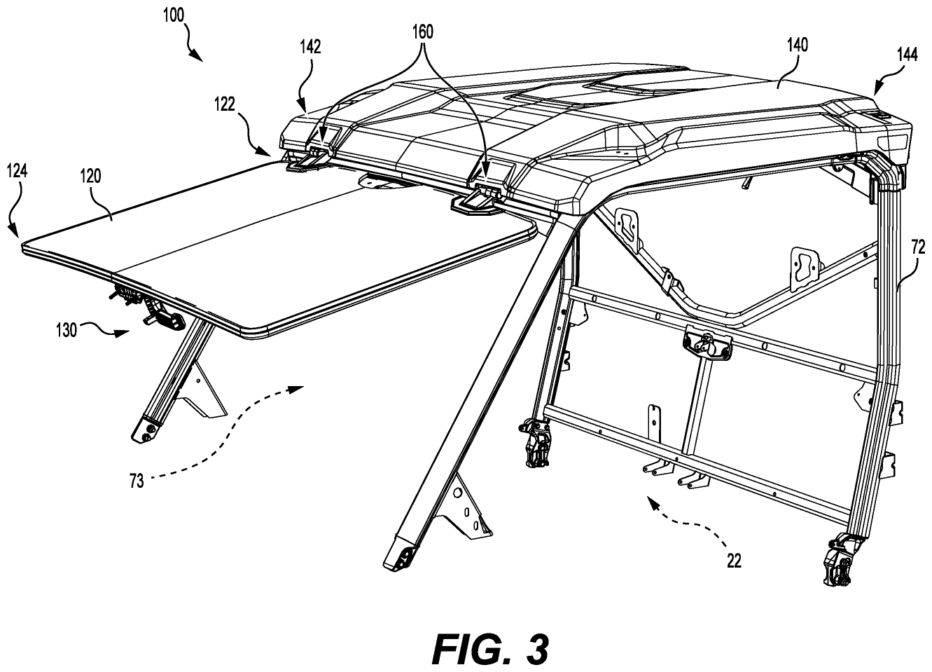

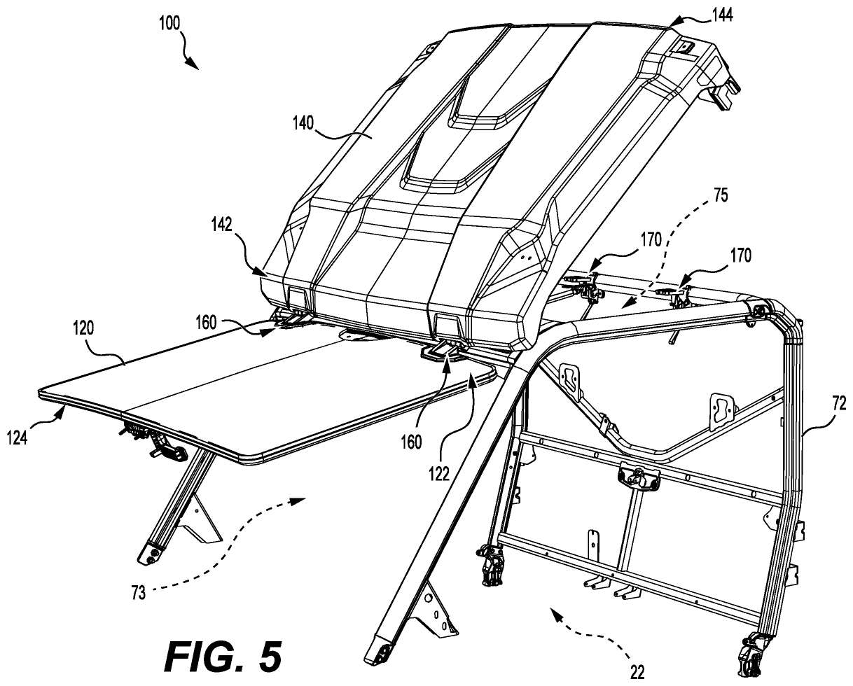

The windshield 120 is selectively moveable, pivoting between a lowered position (FIGS. 1, 2, 4) and a raised position (FIGS. 3, 5). The windshield 120 thus selectively closes a forward portion of the passenger cabin 22. The windshield 120 pivots about a pivot axis 165 of the hinges 160 at a top edge portion 122 of the windshield 120. As such, a lower edge 124 of the windshield 120 is vertically higher in the raised position than in the lowered position. In some embodiments, the windshield 120 could be opened to one or more positions (not shown) intermediate to the lowered position and the raised position. In the lowered position, the windshield 120 impedes access to the forward portion of the passenger cabin 22, protecting occupants of the seats 24 from the environment, for example from wind and dust. Specifically, the windshield 120 closes a forward opening 73 of the ROPS 72. In the raised position, the forward opening 73 is at least partially disengaged and the forward portion of the passenger cabin 22 is accessible and fluidly connected to ambient air surrounding the vehicle 10 through the forward opening 73.

In the illustrated embodiment, the windshield 120 includes a latch 130 for selectively maintaining the windshield 120 in the lowered position. The latch 130 is connected near the lower edge of the windshield 120 to selectively grasp a portion of the vehicle 10 below the bottom edge of the windshield 120 to impede movement thereof. It is contemplated that the windshield 120 could include more than one latch 130. It is also contemplated that the latch 130 could be omitted or connected to a portion of the vehicle 10.

The roof 140 of the assembly 100 is connected to the top of the ROPS 72 via the hinges 160. The roof 140 selectively provides shade to the passengers occupying the cockpit area 22 and protection from the elements, such as rain. The roof 140 is a rigid roof in the illustrated embodiment. It is contemplated that in some embodiments, the roof 140 could be made of flexible material, such a fabric, stretched over a frame.

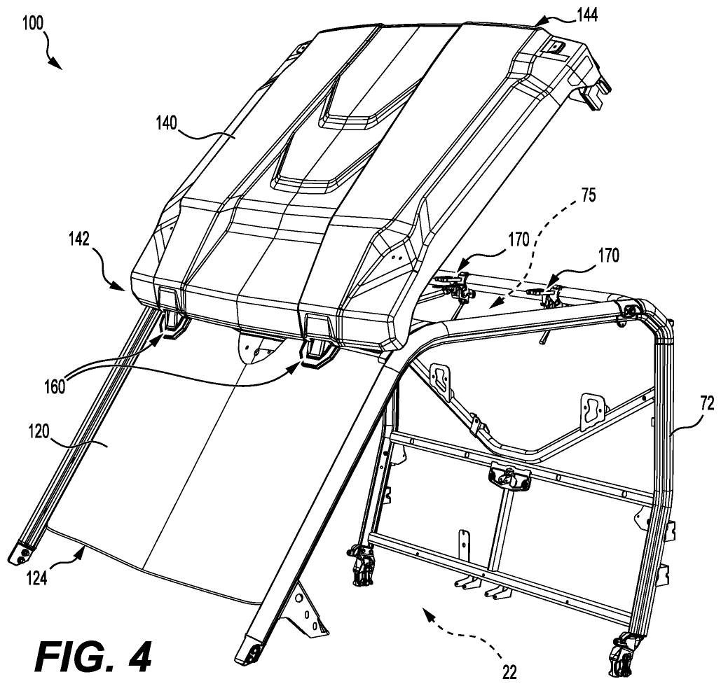

The roof 140 is selectively pivotable between a closed position (FIGS. 1, 2, 3) and a lifted position (FIGS. 4, 5). The roof 140 pivots about the pivot axis 165 of the hinges 160 at a front edge 142 of the roof 140. In the lifted position of the roof 140, a rear edge 144 of the roof 140 is vertically higher than in the closed position. As the roof 140 is generally horizontally arranged in the closed position, the rear edge 144 is vertically higher than the front edge portion 142 of the roof 140 in the lifted position.

The roof 140 selectively closes an upper portion of the passenger cabin 22, specifically via an upper opening 75 in the ROPS 72. In the closed position of the roof 140, the roof 140 impedes access to the upper portion of the passenger cabin 22 via the upper opening 75. In the lifted position of the roof 140, the upper portion of the passenger cabin 22 is accessible and fluidly connected to ambient air surrounding the vehicle 10 via the opening 75.

As is illustrated in FIG. 5, the assembly 100 is arranged such that the windshield 120 can be in the raised position and the roof 140 in the lifted position simultaneously. Similarly, the assembly 100 may be selectively arranged with: the windshield 120 in the raised position and the roof in the closed position (FIG. 3); the windshield 120 in the lowered position and the roof 140 in the lifted position (FIG. 4); and the windshield 120 in the lowered position and the roof 140 in the closed position (FIGS. 1, 2).

While not discussed in detail herein, a variety of arrangements or components could be included in the assembly 100 and/or the vehicle 10 for maintaining the windshield 120 in the raised position or the roof 140 in the lifted position. The vehicle 10 and/or the assembly 100 could include, for example, a gas cylinder for maintaining the windshield 120 in the raised position or the roof 140 in the lifted position.

While not discussed in detail herein, a variety of arrangements or components could be included in the assembly 100 and/or the vehicle 10 for maintaining the roof 140 in the closed position. In the present embodiment, the vehicle 10 and the assembly 100 include, for example, locks 170 on the edge of ROPS 72 connecting the rear edge 144 of the roof 140 for maintaining the roof 140 in the closed position.

With additional reference to FIGS. 6 to 9, one of the hinges 160 is illustrated in more detail. While only one hinge assembly 160 is described below, the two hinge assemblies 160 in a given assembly 100 are generally identical. In some embodiments, the two hinge assemblies 160 could be mirror-image constructions.

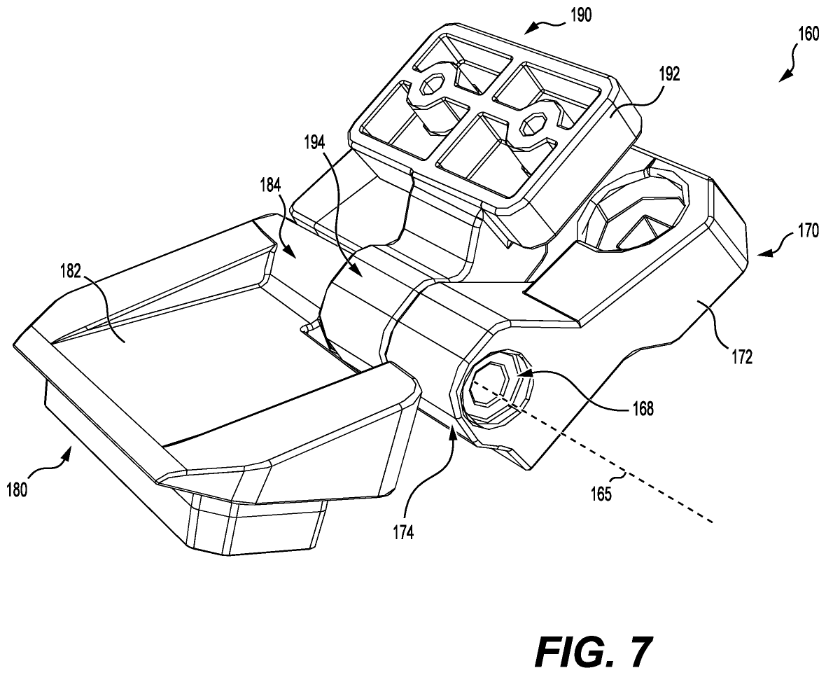

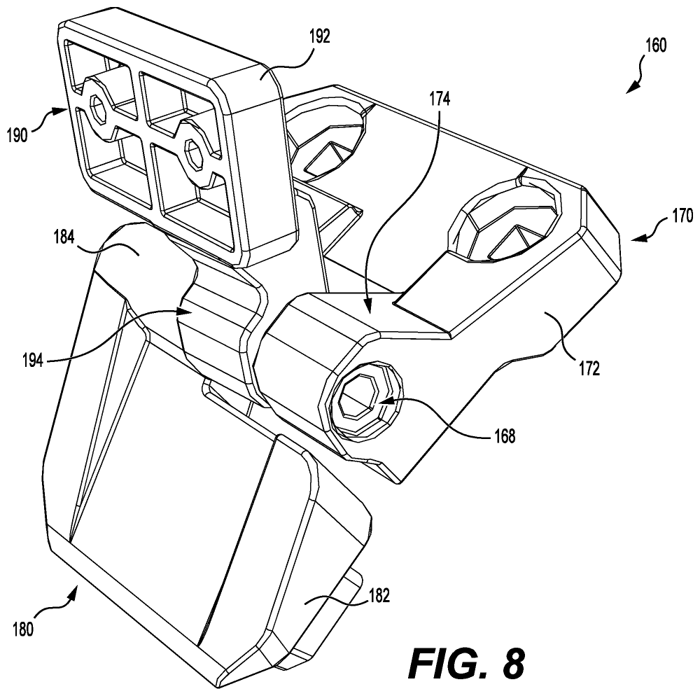

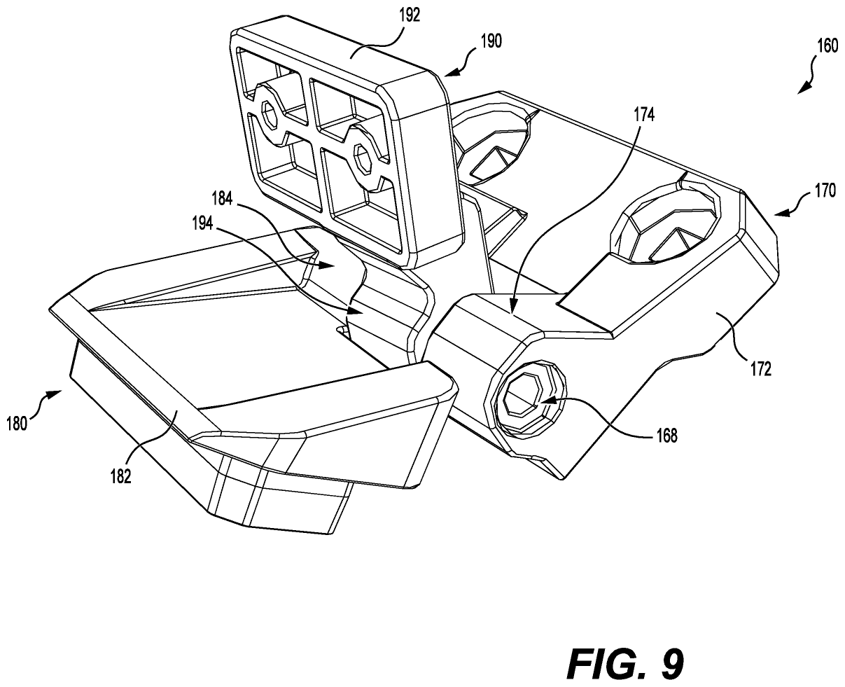

The hinge 160 includes a vehicle portion 170, a windshield portion 180 pivotally connected to the vehicle portion 170, and a roof portion 190 pivotally connected to the vehicle portion 170. FIG. 6 illustrates the hinge 160 is its position corresponding to the arrangement of the windshield 120 in the lowered position and the roof 140 in the closed position. FIG. 7 illustrates the hinge 160 is its position corresponding to the arrangement of the windshield 120 in the raised position and the roof 140 in the closed position. FIG. 8 illustrates the hinge 160 is its position corresponding to the arrangement of the windshield 120 in the lowered position and the roof 140 in the lifted position. FIG. 9 illustrates the hinge 160 is its position corresponding to the arrangement of the windshield 120 in the raised position and the roof 140 in the lifted position.

The vehicle portion 170 is connected to the frame 12 of the vehicle 10. In the present embodiment, the vehicle portion 170 is fastened to the ROPS 72, specifically a forward rigid member of the ROPS 72. In the present embodiment, the assembly 100 is selectively fastened to the vehicle 10 via the vehicle portion 170. The assembly 100 is selectively removable from the ROPS 72 by unfastening the vehicle portion 170 therefrom. It is contemplated that the vehicle portion 170 could be installed on the ROPS 72 in a manner to impede removal of the assembly 100 from the vehicle 10, for instance with rivets.

The windshield portion 180 is fastened to the windshield 120, specifically the top edge portion 122 thereof. Depending on the embodiment, it is contemplated that the windshield 120 could be differently connected to the windshield portion 180. The roof portion 190 is similarly fastened to the roof 140, specifically the forward edge portion 142 thereof. Depending on the embodiment, it is contemplated that the roof 140 could be differently connected to the roof portion 190.

The windshield portion 180 and the roof portion 190 are pivotally connected to the vehicle portion 170, to permit rotation of the windshield 120 and the roof 140 relative to the vehicle portion 170 respectively, through a knuckle and pin structure. Specifically, the vehicle portion 170 includes a vehicle portion body 172 fastened to the vehicle 10 and a vehicle portion knuckle 174 connected to the vehicle portion body 172. The windshield portion 180 includes a windshield portion body 182 fastened to the windshield 120 and a window portion knuckle 184 connected to the windshield portion body 182. Similarly, the roof portion 190 has a roof portion body 192 fastened to the roof 140 and a roof portion knuckle 194 connected to the roof portion body 192.

The hinge 160 further includes a pin 168 to connect together the hinge portions 170, 180, 190. The pin 168 specifically extends through the vehicle portion knuckle 174, the window portion knuckle 184, and the roof portion knuckle 194. The pin 168 defines the pivot axis 165, such that the portions 180, 190 pivot about a same axis relative to the vehicle portion 170. In the illustrated embodiment, the roof portion 190 is disposed between the vehicle portion 170 and the windshield portion 180 circumferentially about the pivot axis 165. The roof portion knuckle 194 is also disposed laterally between the vehicle portion knuckle 174 and the windshield portion knuckle 184 in the present embodiment. It is contemplated that the lateral order of the knuckles 174, 184, 194 could vary in some embodiments.

In some embodiments, it is contemplated that the windshield portion 180 and the roof portion 190 could pivot about parallel, but not co-axial pivot axes. For instance, the vehicle portion 170 could include two knuckle section, one for each portion 180, 190.

To permit pivoting of the portions 180, 190, one end of the pin 168 is fixed inside the knuckles 174, 184, 194 by a c-clip (not shown), with the opposite end abutting the vehicle portion knuckle 174. It is contemplated that the pin 168 could be threaded and rotationally fixed to one of the knuckles 174, 184, 194. The portions 170, 180, 190 of the hinge 160 are thus pivotally connected through the knuckles 174, 184, 194 and the pin 168. With this arrangement, the windshield portion 180 and the roof portion 180 pivot about the common pivot axis 165 relative to the vehicle portion 170.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A windshield and roof assembly for an off-road vehicle, the assembly comprising:
a windshield comprising:
a top edge, and
a lower edge opposite the top edge;
a roof comprising:
a front edge, and
a rear edge opposite the front edge; and
at least one hinge assembly comprising:
a vehicle portion configured for connecting to a frame member of the vehicle,
a windshield portion pivotally connected to the vehicle portion, the windshield being connected to the windshield portion near the top edge of the windshield, and
a roof portion pivotally connected to the vehicle portion, the roof being connected to the roof portion near the front edge of the roof.

2. The windshield and roof assembly of claim 1, wherein the at least one hinge assembly is configured such that, when the windshield and roof assembly is installed on the off-road vehicle:
the vehicle portion is connected to the frame member of the vehicle;
the windshield is pivotable between at least a lowered position and a raised position, the lower edge of the windshield being vertically higher in the raised position than in the lowered position; and
the roof is pivotable between at least a closed position and a lifted position, the rear edge of the roof being vertically higher in the lifted position than in the closed position.

3. The windshield and roof assembly of claim 1, wherein:
the windshield portion pivots about a first axis relative to the vehicle portion; and
the roof portion pivots about a second axis relative to the vehicle portion, the second axis being parallel to the first axis.

4. The windshield and roof assembly of claim 1, wherein:
the windshield portion is fastened to the windshield; and
the roof portion is fastened to the roof.

5. The windshield and roof assembly of claim 1, wherein the windshield portion and the roof portion pivot about a same pivot axis relative to the vehicle portion.

6. The windshield and roof assembly of claim 5, wherein the roof portion is disposed between the vehicle portion and the windshield portion circumferentially about the pivot axis.

7. The windshield and roof assembly of claim 1, wherein the windshield further comprises at least one latch for selectively maintaining the windshield in the lowered position, the at least one latch being connected near the lower edge of the windshield.

8. The windshield and roof assembly of claim 1, wherein the at least one hinge assembly includes:
a left hinge assembly connected to a left side portion of the windshield and a left side of the roof; and
a right hinge assembly connected to a right side portion of the windshield and a right side of the roof.

9. The windshield and roof assembly of claim 1, wherein the at least one hinge assembly is a plurality of hinge assemblies connected to the windshield and the roof.

10. The windshield and roof assembly of claim 1, wherein:
the vehicle portion comprises:
a vehicle portion body configured to be fastened to the vehicle, and
a vehicle portion knuckle;
the windshield portion comprises:
a windshield portion body fastened to the windshield, and
a windshield portion knuckle;
the roof portion comprises:
a roof portion body fastened to the roof, and
a roof portion knuckle; and
a pin extending through the vehicle portion knuckle, the windshield portion knuckle, and the roof portion knuckle.

11. An off-road vehicle comprising:
a frame including a rollover protection structure;
two front wheels operatively connected to the frame;
two rear wheels operatively connected to the frame;
at least one seat supported by the frame;
a motor supported by the frame and being operatively connected to at least one of:
the two rear wheels; and
the two front wheels; and
a windshield and roof assembly comprising:
a windshield comprising:
a top edge, and
a lower edge opposite the top edge;
a roof comprising:
a front edge, and
a rear edge opposite the front edge; and
at least one hinge assembly comprising:
a vehicle portion connected to the rollover protection structure,
a windshield portion rotationally connected to the vehicle portion, the windshield being connected to the windshield portion near the top edge of the windshield, and
a roof portion rotationally connected to the vehicle portion, the roof being connected to the roof portion near the front edge of the roof.

12. The vehicle of claim 11, wherein:
the windshield is pivotable between at least a lowered position and a raised position, the lower edge of the windshield being vertically higher in the raised position than in the lowered position; and
the roof is pivotable between at least a closed position and a lifted position, the rear edge of the roof being vertically higher in the lifted position than in the closed position.

13. The vehicle of claim 12, wherein, in the lifted position of the roof, the rear edge of the roof is vertically higher than the front edge of the roof.

14. The vehicle of claim 12, wherein:
a passenger cabin of the vehicle is at least partially defined by the rollover protection structure;
the roof selectively closes an upper portion of the passenger cabin;
in the closed position of the roof, the roof impedes access to the upper portion of the passenger cabin; and
in the lifted position of the roof, the upper portion of the passenger cabin is accessible and fluidly connected to ambient air surrounding the vehicle.

15. The vehicle of claim 14, wherein:
the windshield selectively closes a forward portion of the passenger cabin;
in the lowered position of the windshield, the windshield impedes access to the forward portion of the passenger cabin; and
in the raised position of the windshield, the forward portion of the passenger cabin is accessible and fluidly connected to ambient air surrounding the vehicle through a forward portion of the vehicle.

16. The vehicle of claim 11, wherein:
the windshield portion pivots about a first axis relative to the vehicle portion; and
the roof portion pivots about a second axis relative to the vehicle portion, the second axis being parallel to the first axis.

17. The vehicle of claim 11, wherein the windshield portion and the roof portion pivot about a same pivot axis relative to the vehicle portion.

18. The vehicle of claim 17, wherein the roof portion is disposed between the vehicle portion and the windshield portion circumferentially about the pivot axis.

19. The vehicle of claim 12, wherein the windshield further comprises at least one latch for selectively maintaining the windshield in the lowered position, the at least one latch being connected near the lower edge of the windshield.

20. The vehicle of claim 11, wherein the at least one hinge assembly includes:
a left hinge assembly connected to the windshield, the roof, and the frame left of a longitudinal centerline of the windshield; and
a right hinge assembly connected to the windshield, the roof, and the frame right of the longitudinal centerline of the windshield.
